(19) United States
(12) Patent Application Publication
(10) Pub. No.: US 2023/0221774 A1
(43) Pub. Date: Jul. 13, 2023

(54) HINGES WITH ROTATIONAL MOVING BARS

(71) Applicant: Hewlett-Packard Development Company, L.P., Spring, TX (US)

(72) Inventors: Hyunmin Moon, Spring, TX (US); Mark Senatori, Spring, TX (US)

(73) Assignee: Hewlett-Packard Development Company, L.P., Spring, TX (US)

(21) Appl. No.: 17/997,169

(22) PCT Filed: May 19, 2020
(86) PCT No.: PCT/US2020/033580

§ 371 Date: Oct. 26, 2022

(51) Int. Cl. G06F 1/16; F16C 11/04

(52) U.S. Cl. CPC G06F 1/1681; F16C 11/04; G06F 1/1641

(57) ABSTRACT

In example implementations, a hinge for a dual-display device is provided. The hinge includes a positional member, a moving force member, and a moving bar. The positional member includes a first side and a second side. The first side includes a protrusion to divide the first side between a first position and a second position. The moving force member is coupled to a housing of a first display of the dual-display device. The moving force member is positioned against the second side of the positional member to allow the positional member to return to a resting position when moved. A first end of the moving bar is positioned against the first side of the positional member. The moving bar includes an axis of rotation that is transverse to a length of the moving bar to rotate the moving bar between the first position and the second position.

### BACKGROUND

Computing devices are used to provide productivity for users. The computing devices can execute various applications and come in various form factors. For example, computing devices can be desktop computers or mobile computers. An example of a mobile computer may include a laptops or a tablet that includes a display and a keyboard.

### BRIEF DESCRIPTION OF THE DRAWINGS

FIG. 1 is a cross-sectional side view of an example hinge with rotational moving bar of the present disclosure;

FIG. 2 is a cross-sectional side view of an example housing that includes a hinge with a rotational moving bar, a positional member, and a moving force member of the present disclosure;

FIG. 3 is a cross-sectional top view of an example computing device that includes the hinge with rotational moving bar of the present disclosure;

FIG. 4 is an example process flow diagram to illustrate how the hinge with rotational moving bar operates to move between a first closed position and a second closed position of the present disclosure;

FIG. 5 is a side cross-sectional view of an example of a computing device in a first closed position that includes two housings that each include the hinge with rotational moving bar of the present disclosure; and

FIG. 6 is a side cross-sectional view of an example of a computing device in a second closed position that includes two housings that each include the hinge with rotational moving bar of the present disclosure.

### DETAILED DESCRIPTION

Examples described herein provide a movable hinge for dual-display devices. Mobile computers may have various arrangements, form factors, and sizes. One example of a mobile computer is a dual-display device that includes a keyboard. The keyboard may connect wirelessly to the dual-display device and may be stored between the dual-displays when the dual-displays are folded together. However, some hinges may have a single closed position. As a result, when the keyboard is not placed between the dual-displays, a gap may be formed between the displays.

The present disclosure provides a hinge with a rotational bar that can have multiple closed positions. In an example, the hinge may include a moving bar that can be set against a positional member that can hold the moving bar in two different closing positions. A first closed position may include a position to close the dual-displays against a keyboard that is inserted between the dual-displays. A second closed position may include a position to close the dual-displays against one another without the keyboard. Thus, the hinge of the present disclosure may eliminate a gap between the dual-displays even when the dual-displays are folded to close without the keyboard.

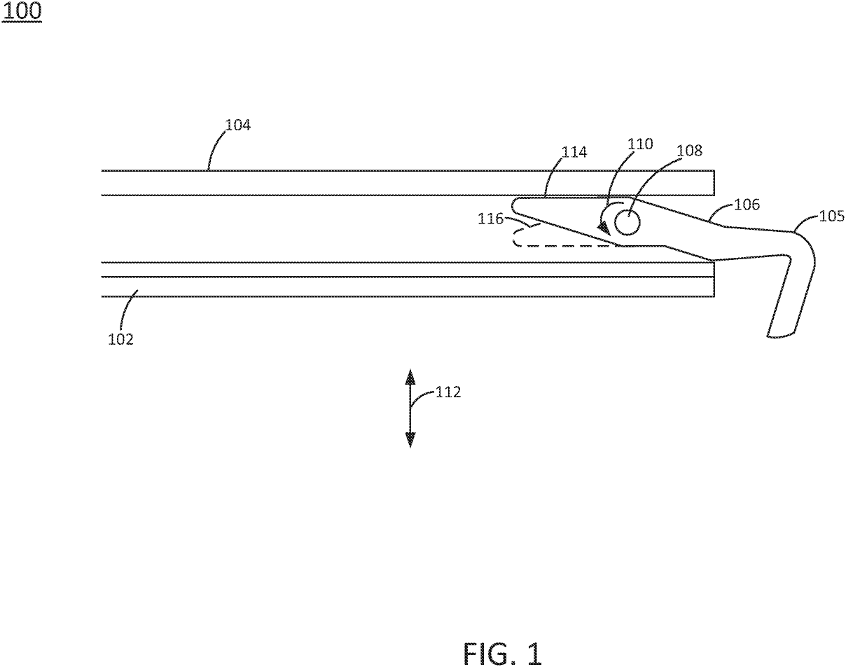

FIG. 1 illustrates an example computing device 100 with a hinge 105 with a rotational moving bar 106 that can move a housing between two different closed positions of the present disclosure. It should be noted that FIG. 1 has been simplified for ease of explanation. For example, the computing device 100 may include additional components that are not shown. For example, the computing device 100 may include a processor, a memory, a power supply, a printed circuit board, interface ports, communication interfaces, input/output peripheral devices, and the like.

In an example, the computing device 100 may include a display 102 that is enclosed by a housing 104. The display 102 may be a light emitting diode (LED) based display. The housing 104 may include a hinge 105 that is coupled to the housing 104. The hinge 105 may include a moving bar 106 that may rotate around an axis of rotation 108 as shown by an arrow 110. In an example, the axis of rotation 108 may be a bar or rivet that may be located approximately in a center of a body of the moving bar 106. The bar or rivet may be movably coupled to a part of the housing 104.

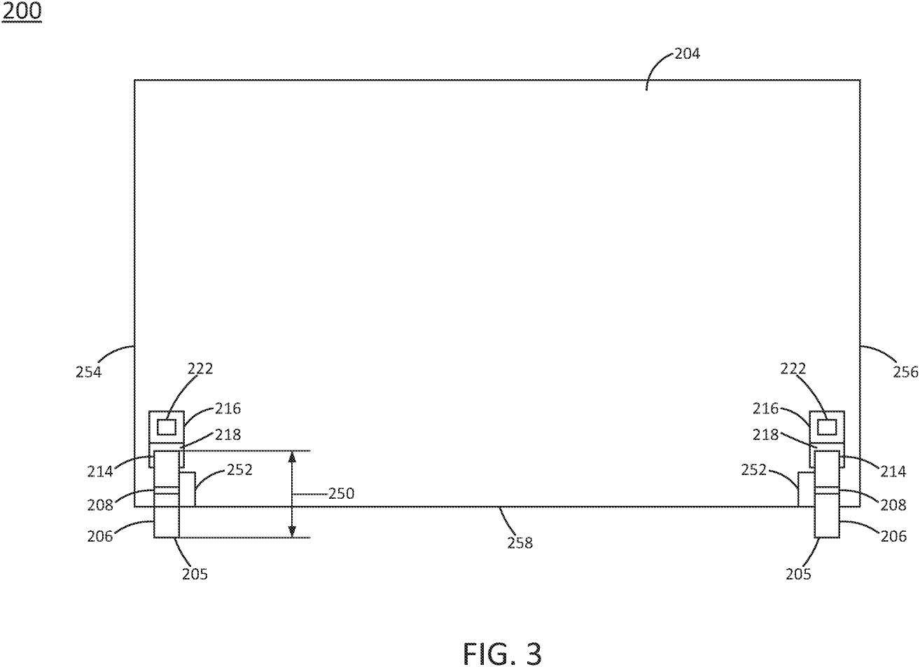

In an example, the axis of rotation 108 may be transverse to a length of the moving bar 106. For example, the length of the bar or rivet that forms the axis of rotation 108 may be perpendicular to a z-axis 112 of movement of an end 114 of the moving bar 106. Further details are illustrated in FIG. 3, and discussed in further details below regarding the arrangement of the axis of rotation 108.

In an example, the moving bar 106 may rotate around the axis of rotation 108 to move the end 114 of the moving bar 106 along the z-axis 112. In other words, rotation of the moving bar 106 around the axis of rotation 108 may cause the end 114 of the moving bar to move up and down within a volume of the housing 104. The movement of the end 114 may be shown in phantom lines 116 between a first closed position and a second closed position.

As discussed in further details below, the display 102 may be part of a dual-display device. The dual-display device may fold in a “clamshell” design to close. The dual-display device may be closed around a removable keyboard or closed without the keyboard. Thus, a first closed position may include the dual-display device closed or folded around the removable keyboard. For example, the display 102 may rest against the removable keyboard.

A second closed position may include the dual-display device closed without the removable keyboard. For example, the display 102 may rest against an opposing display (not shown) of the dual-display device. The two closed positions may allow the dual-display device to be closed without a gap between the displays when closed without the removable keyboard.

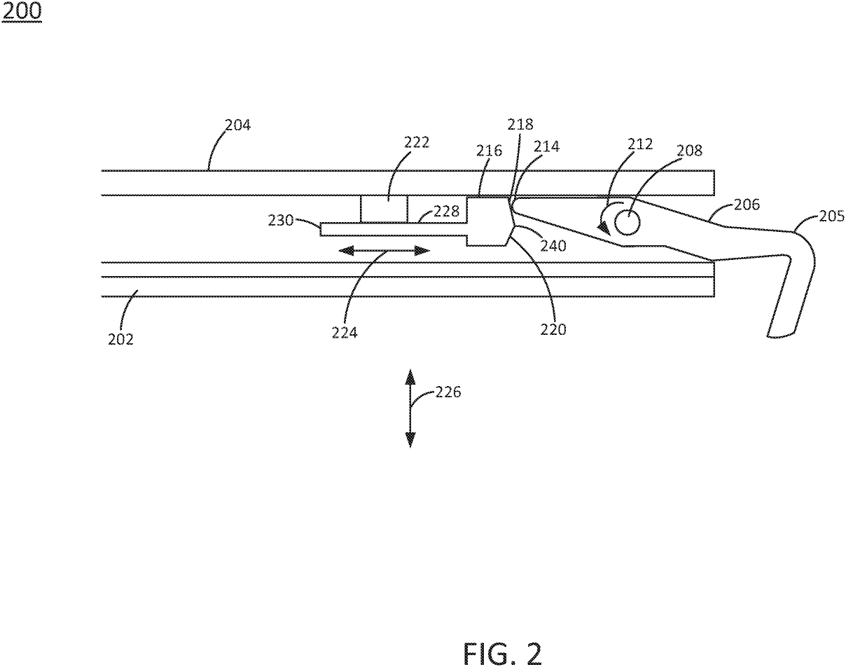

FIG. 2 illustrates a cross-sectional side view of an example computing device 200 that includes a housing 204 that includes a hinge 205 with a rotational moving bar 206, a positional member 216, and a moving force member 222 of the present disclosure. It should be noted that FIG. 2 has been simplified for ease of explanation. For example, the computing device 200 may include additional components that are not shown. For example, the computing device 200 may include a processor, a memory, a power supply, a printed circuit board, interface ports, communication interfaces, input/output peripheral devices, and the like.

In an example, the computing device 200 may include a display 202 that is enclosed by athe housing 204. The display 202 may be a light emitting diode (LED) based display. The housing 204 may include the hinge 205 that is coupled to the housing 204. The hinge 205 may include the moving bar 206 that may rotate around an axis of rotation 208 as shown by an arrow 210. In an example, the axis of rotation 208 may be a bar or rivet that may be located approximately in a center of a body of the moving bar 206. The bar or rivet may be movably coupled to a part of the housing 204.

In an example, the axis of rotation 208 may be transverse to a length of the moving bar 206. For example, the length of the bar or rivet that forms the axis of rotation 208 may be perpendicular to a z-axis 226 of movement of an end 214 of the moving bar 206. Further details are illustrated in FIG. 3, and discussed in further details below regarding the arrangement of the axis of rotation 208.

In an example, the moving bar 206 may rotate around the axis of rotation 208 to move the end 214 of the moving bar 206 along the z-axis 226. In other words, rotation of the moving bar 206 around the axis of rotation 208 may cause the end 214 of the moving bar to move up and down within a volume of the housing 204.

In an example, the hinge 205 may also include the positional member 216 and the moving force member 222. The positional member 216 may be a slider that can move laterally (e.g., side-to-side or left to right along the page as shown by an arrow 224) coupled to the moving force member 222. The moving force member 222 may be coupled to an inside surface of the housing 204.

The positional member 216 may include a first side that includes a protrusion 240 that divides a first surface 218 that is associated with a first closed position and a second surface 220 that is associated with a second closed position. In an example, the protrusion 240 may form an apex where the first surface 218 and the second surface 220 meet at an angle.

It should be noted that although the positional member 216 is illustrated as having a particular shape, any shape that has a protrusion to divide the surfaces 218 and 220 may be deployed. For example, the surfaces 218 and 220 may be vertically flat and the protrusion may be a rounded bump or divider. In another example, the surfaces 218 and 220 may include an indentation or a notch where the end 214 of the moving bar 206 may come to rest. The positional member 216 may be a portion that divides the notch of the surface 218 and the notch of the surface 220.

In addition, although the moving bar 206 is illustrated as having a particular shape, it should be noted that moving bar 206 may have any shape that works with the shape of the surfaces 218 and 220 of the positional member 216. However, the end 214 of the moving bar 206 may be shaped such that the end 214 can cause the positional member 216 to move laterally (as shown by the arrow 224). For example, as the moving bar 206 rotates around the axis of rotation 208, the end 214 of the moving bar 206 may push against the surface 218. The force of the end 214 pushing against the surface 218 may cause the positional member 216 to slide away from the moving bar 206 until the end 214 of the moving bar 206 clears the protrusion 240.

In an example, the moving force member 222 may apply a constant force to the positional member 216 towards a resting position. For example, a position of the positional member 216 when the end 214 is against the first surface 218 or the second surface 220 may be defined as the resting position. The positional member 216 may move away from the resting position when the end 214 is moved by rotation of the moving bar 206 between the first surface 218 and the second surface 220. After the end 214 clears the protrusion 240, the force applied by the moving force member 222 may allow the positional member 216 to automatically return to the resting position after being moved.

In an example, the moving force member 222 may be coupled to a flat surface 228 of a second side of the positional member 216. The moving force member 222 may be a mechanical spring (e.g., a helical compression spring, a helical extension spring, a conical spring, a torsion spring, and the like). In an example, the moving force member 222 may be an electronically or pneumatically controlled device or piston. In an example, more than one moving force member 222 may be deployed. For example, two springs may be coupled in a line along the flat surface 228 of the second side of the positional member 216.

Although the moving force member 222 is show as being coupled vertically above the positional member 216, it should be noted that the moving force member 222 may be positioned in a variety of different arrangements. For example, the moving force member 222 may be positioned laterally or along a side of the positional member 216 or may be positioned laterally behind an end 230 of the positional member 216.

FIG. 3 illustrates a cross-sectional top view of an example of the computing device 200 that includes the hinge 205 with the rotational moving bar 206 of the present disclosure. FIG. 3 illustrates how the hinge 205 may be coupled an end 258 near opposing sides 254 and 256 of the housing 204. For example, the computing device 200 may include two hinges 205 illustrated in FIG. 2, and described above.

FIG. 3 helps to illustrate how the axis of rotation 208 may be transverse to a length 250 of the moving bar 206. As shown in FIG. 3, the bar or rivet that forms the axis of rotation 208 may span from side-to-side of the moving bar 206. The axis of rotation 208 may be approximately perpendicular to the length 250 of the moving bar 206.

In an example, the axis of rotation 208 may be coupled to a member 252 of the housing 204. For example, a block or protruding member may be molded or coupled to the inside surface of the housing 204. An end of the axis of rotation 208 may be movably coupled to the member 252.

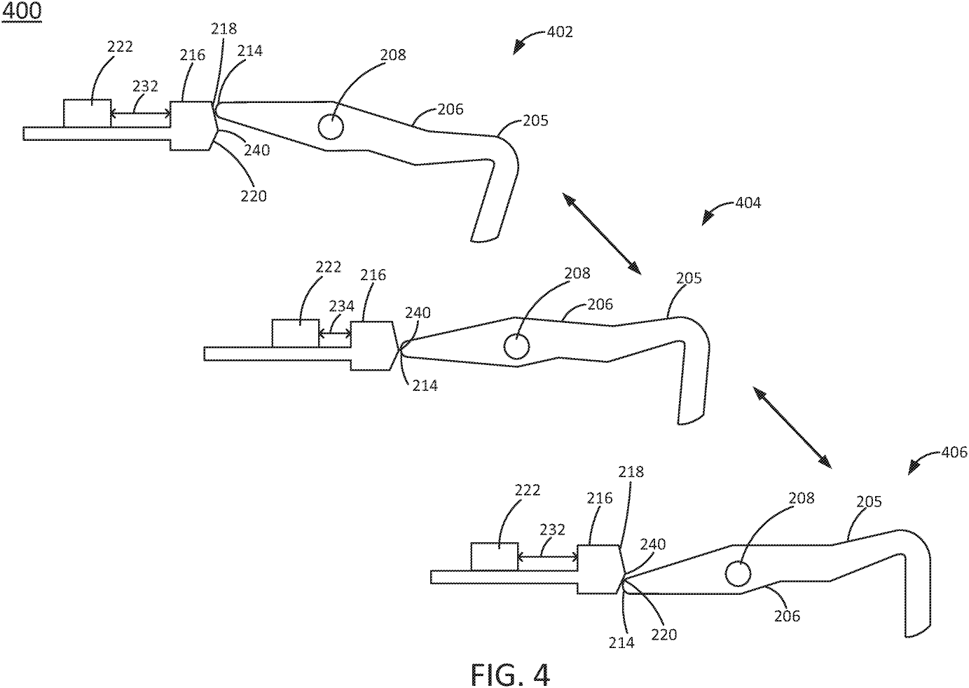

FIG. 4 illustrates an example process flow 400 to illustrate how the hinge 205 may move between a first closed position and a second closed position. In the example illustrated in FIG. 4, the first surface 218 and the second surface 220 of the positional member 216 may be inclined surfaces that are angled to meet at an apex. Thus, the protrusion 240 in the example illustrated in FIG. 4 may be an apex. The first surface 218 may be associated with a first closed position and the second surface 220 may be associated with a second closed position.

At block 402, the end 214 of the moving bar 206 may be resting against the first surface 218. The positional member 216 may be at a resting position that has a distance 232 away from the moving force member 222.

At block 404, the end 214 of the moving bar 206 may begin to move vertically down as the moving bar 206 rotates around the axis of rotation 208. In an example, a user may be pushing the housing 204 down to reposition the housing 204 from the first closed position to a second closed position.

The block 404 illustrates a point where the end 214 is at the protrusion or apex 240 and the positional member 216 is pushed away from the end 214 by a maximum distance. In other words, positional member 216 has moved closer to the moving force member 222 at a distance 234 in the block 404. The distance 234 may be a minimum distance or the closest the positional member 216 may be to the moving force member 222.

At block 406, the end 214 may clear the protrusion or apex 240 and rest against the second surface 220 of the positional member 216. As the end 214 clears the protrusion or apex 240, the moving force member 222 may apply a force against the positional member 216 to return to the resting position. For example, the positional member 216 may be in a resting position at a distance 232 away from the moving force member 222.

In an example, the moving force member 222 may be a spring. As the spring is deformed laterally by the movement of the positional member 216, the spring force constant may cause the spring to return to a starting shape. The spring force constant may pull the positional member 216 back towards the resting position at a distance 232 away from the moving force member 222.

It should be noted that the process flow 400 may be performed in either direction. For example, from the block 406, the process flow 400 may be repeated in the other direction towards the block 402 as the housing 204 is moved back to the first closed position.

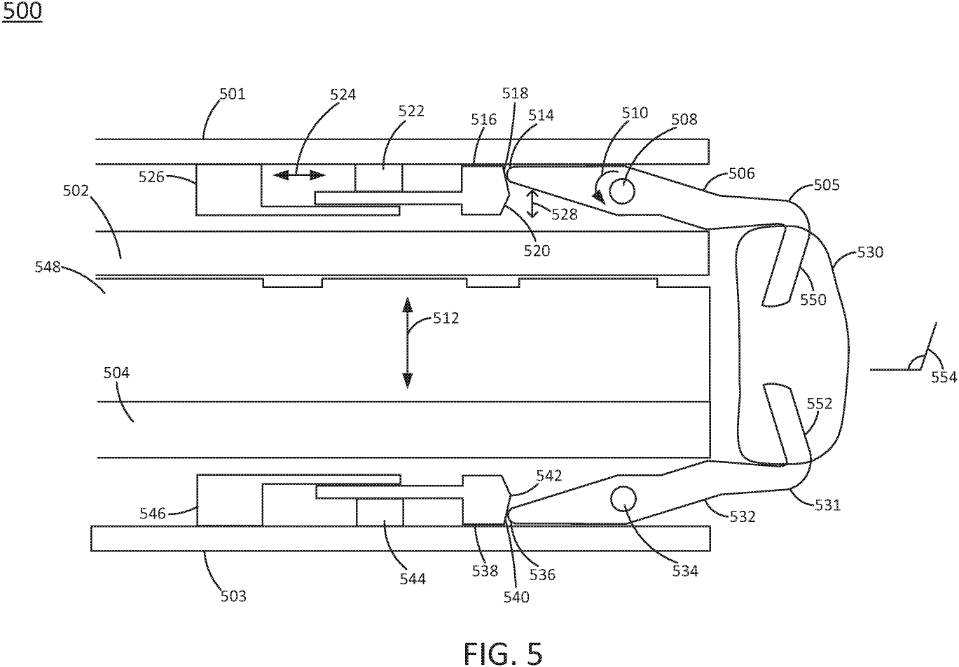

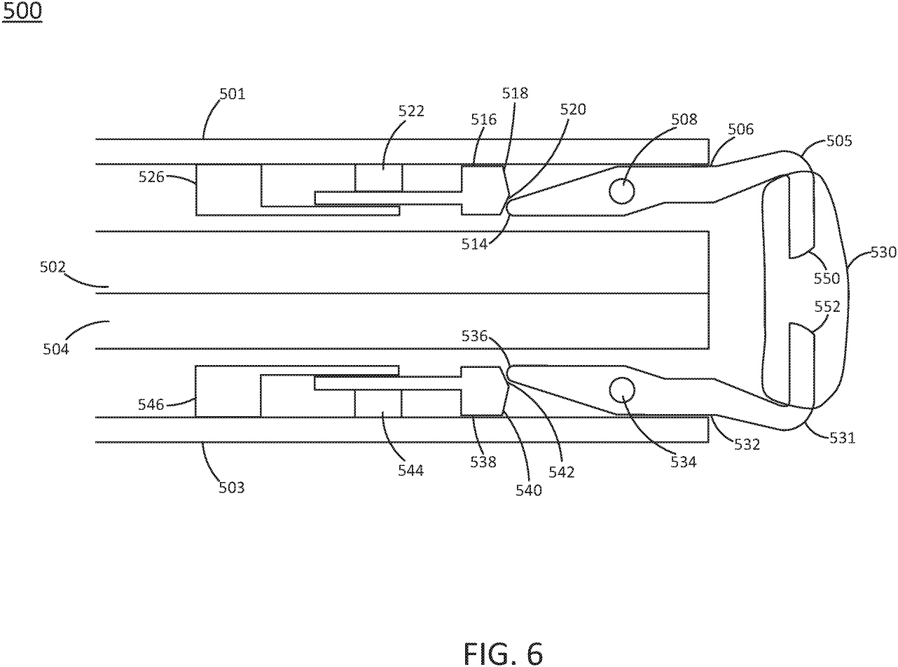

FIGS. 5 and 6 illustrate cross-sectional views of a computing device 500 that includes hinges 505 and 531 of the present disclosure. FIG. 5 illustrates a first closed position that includes a removable keyboard 548. FIG. 6 illustrates a second closed position where the removable keyboard 548 is removed. It should be noted that the computing device 500 in FIGS. 5 and 6 have been simplified for ease of explanation. For example, the computing device 500 may include additional components that are not shown. For example, the computing device 500 may include a processor, a memory, a power supply, a printed circuit board, interface ports, communication interfaces, input/output peripheral devices, and the like.

Referring to FIG. 5, the computing device 500 may be a dual-display device that includes a first display 502 and a second display 504. The light emitting sides of the first display 502 and the second display 504 may be orientated to face one another when in the first closed position. The first display 502 may be enclosed by a first housing 501 and the second display 504 may be enclosed by a second housing 503.

In an example, the first housing 501 may include a first hinge 505 and the second housing 503 may include a second hinge 531. A second end 550 of the first hinge 505 and a second end 552 of the second hinge 531 may be coupled together by a coupling member 530. The second ends 550 and 552 may be movably coupled to the coupling member 530. The coupling member 530 may allow the second ends 550 and 552 to move such that the first display 502 and the second display 504 may be moved into an open position. For example, the open position may cause the display 502 to rotate away from the display 504 to a 90 degree angle or greater as shown by the angle 554.

In an example, the first hinge 505 may include a moving bar 506, a positional member or slider 516, a moving force member 522 and a limiting member 526. The moving bar 506 may include an axis of rotation 508 and an end 514. The axis of rotation 508 may allow the moving bar 506 to rotate as shown by an arrow 510. The rotation of the moving bar 506 may allow the end 514 to move up and down as shown by an arrow 528. The positional member 516 may include a first surface 518 and a second surface 520. The first surface 518 may be associated with a first closed position with the removable keyboard 548. The second surface 520 may be associated with a second closed position without the removable keyboard 548.

The positional member 516 may slide laterally as shown by an arrow 524. The moving force member 522 may move the positional member 516 back to a resting position after being moved by the moving bar 506. The moving bar 506, the positional member 516, and the moving force member 522 may operate as shown by blocks 402-406 of the process flow 400 illustrated in FIG. 4, and discussed above.

In an example, the limiting member 526 may be coupled to an inside surface of the first housing 501. The limiting member 526 may provide a surface to stop movement of the positional member 516. For example, the limiting member 526 may provide additional mechanical support to reduce the likelihood that the positional member 516 moves the moving force member 522 past a breaking point. As noted above, the moving force member 522 may be a spring. The breaking point may be a point or distance where the spring will no longer return to its original shape (e.g., the restoring force of the spring equals zero). The limiting member 526 may reduce the likelihood that the spring reaches past the breaking point when the positional member 516 is moved.

The second housing 503 may include the second hinge 531. In an example, the second hinge 531 may include a moving bar 532, a positional member or slider 538, a moving force member 544, and a limiting member 546. The moving bar 532 may include an axis of rotation 534 and an end 536. The moving bar 532 may rotate to cause the end 536 to move up and down similar to the moving bar 506, as described above. The positional member 538 may include a first surface 540 and a second surface 542. The first surface 540 may be associated with a first closed position with the removable keyboard 548. The second surface 542 may be associated with a second closed position without the removable keyboard 548.

The positional member 538 may slide laterally similar to the positional member 516. The moving force member 544 may move the positional member 538 back to a resting position after being moved by the moving bar 532. The moving bar 532, the positional member 538, and the moving force member 544 may operate as shown by blocks 402-406 of the process flow 400 illustrated in FIG. 4, and discussed above.

The second hinge 531 may also include the limiting member 546. The limiting member may be coupled to an inside surface of the second housing 503. The limiting member 546 may provide a surface to control an amount of movement of the positional member 538, similar to the limiting member 526, as described above.

FIG. 5 illustrates a first closed position where surfaces of the first display 502 and the second display 504 rest against the removable keyboard 548. When the removable keyboard 548 is removed, the first display 502 and first housing 501 may be moved against the second display 504 and the second housing 503. For example, the first hinge 505 and the second hinge 531 may allow the first housing 501 and the second housing 503 to move in a direction along the z-axis as shown by a line 512.

FIG. 6 illustrates the computing device 500 in a second closed position with the keyboard 548 removed. As illustrated in FIG. 6, the surface of the first display 502 may rest against the second display 504. Notably, there is no gap or substantial space between the first display 502 and the second display 504.

As noted above, the first hinge 501 may operate from the first closed position to the second closed position in a manner illustrated by the process flow 400 illustrated in FIG. 4. The second hinge 503 may operate in a similar manner, but in an opposite direction.

Thus, the first hinge 505 and the second hinge 531 with the rotational moving bars 506 and 532, respectively, may allow the computing device 500 to have two closed positions. The two closed positions may allow a gap between the first display 502 and the second display 504 to be eliminated when the removable keyboard 548 is removed.

It will be appreciated that variants of the above-disclosed and other features and functions, or alternatives thereof, may be combined into many other different systems or applications. Various presently unforeseen or unanticipated alternatives, modifications, or variations therein may be subsequently made by those skilled in the art which are also intended to be encompassed by the following claims.

1. A computing device, comprising:
a display;
a housing to enclose the display; and
a hinge coupled to the housing, the hinge comprising:
a moving bar positioned within the housing, wherein the moving bar includes an axis of rotation that is transverse to a length of the moving bar, wherein the moving bar is to:
rotate an end of the moving bar along a z-axis inside of the housing; and
move the display between a first closed position and a second closed position.

2. The computing device of claim 1, the hinge further comprising:
a positional member positioned inside of the housing, wherein a first side of the positional member includes a protrusion to divide the first side between a first surface associated with the first closed position and a second surface associated with the second closed position.

3. The computing device of claim 2, wherein the end of the moving bar is to rest against the first side of the positional member.

4. The computing device of claim 3, wherein rotation of the moving bar causes the positional member to clear the protrusion from the end of the moving bar to allow the moving bar to move between the first closed position and the second closed position of the positional member.

5. The computing device of claim 2, the hinge further comprising:
a moving force member coupled to an inside surface of the housing and the positional member, wherein the moving force member is to apply a force to the positional member to allow the positional member to return to a resting position after the positional member is moved by the end of the moving bar.

6. The computing device of claim 1, wherein the first closed position causes the display to rest against a second display.

7. The computing device of claim 1, wherein the second closed position causes the display to rest against a keyboard positioned between the display and a second display.

8. A computing device, comprising:
a first housing;
a first hinge coupled to the first housing, the first hinge comprising:
a first moving bar that includes a first end that rotates along a z-axis within the first housing to move the first housing between a first closed position and a second closed position;
a second housing;
a second hinge coupled to the second housing, the second hinge comprising:
a second moving bar that includes a first end that rotates along a z-axis within the second housing to move the second housing between the first closed position and the second closed position; and
a coupling member coupled to a second end of the first moving bar and a second end of the second moving bar to allow the first housing and the second housing to move into an open position.

9. The computing device of claim 8, wherein the first hinge further comprises:
a slider, wherein the slider includes a first side and a second side, wherein the first side includes a first surface and a second surface that are angled to form an apex.

10. The computing device of claim 9, wherein the first hinge further comprises:
a spring coupled to the second side of the slider and an inside surface of the first housing.

11. The computing device of claim 10, wherein the first end of the first moving bar is to move against the first surface to cause the slider to move laterally away from the first moving bar and the spring is to cause the slider to return to a resting position after the first end of the first moving bar clears the apex.

12. A computing device, comprising:
a display;
a housing to enclose the display; and
a hinge coupled to the housing, the hinge comprising:
a slider, wherein the slider includes a first inclined surface and a second inclined surface;
a spring coupled to a second side of the slider; and
a moving bar comprising an axis of rotation that allows a first end of the moving bar to rotate along a z-axis within the housing,
wherein the first end of the moving bar is positioned against a first side of the slider to move between the first inclined surface and the second inclined surface,
wherein the spring is to cause the slider to return to a resting position when moved by the first end of the moving bar.

13. The computing device of claim 12, wherein the first inclined surface is associated with a first closed position of the display, wherein the first closed position comprises the display closed against a keyboard that is positioned between the display and a second display.

14. The computing device of claim 12, wherein the second inclined surface is associated with a second closed position of the display, wherein the second closed position comprises the display closed against a second display.

15. The computing device of claim 12, wherein the hinge further comprises:
a limiting member to limit an amount of movement of the slider.
